(19) United States
(12) Patent Application Publication
(10) Pub. No.: US 2009/0229917 A1
(43) Pub. Date: Sep. 17, 2009

(54) Tree Stand

(76) Inventor: Ronald L. Berkbuegler, Troy, IL (US)

Correspondence Address: SENNIGER POWERS LLP, 100 NORTH BROADWAY, 17TH FLOOR, ST LOUIS, MO, 63102, US

(21) Appl. No.: 12/403,289

(22) Filed: Mar. 12, 2009

Related U.S. Application Data
(60) Provisional application No. 61/035,766, filed on Mar. 12, 2008.

(51) Int. Cl. A01M 31/02; A45F 3/26; E04G 5/14; E04G 3/00

(52) U.S. Cl. 182/113; 182/187; 182/129

(57) ABSTRACT

A tree stand may include an engagement component for engaging a tree trunk. The engagement component includes spaced apart engagement arms that are pivotable generally toward one another generally within a plane so that the engagement component is generally conformable to a circumferential segment of the tree trunk. Rails of the stand may be movable laterally. The rails may include a front arm and a rear arm, where the front arm is positionable relative to the rear arm. The stand may include a canopy assembly that is configurable between an extended, covering position and a retracted, uncovering position.

### CROSS-REFERENCE TO RELATED APPLICATION

This application claims priority to U.S. Provisional Application No. 61/035,766, filed Mar. 12, 2008, the entirety of which is herein incorporated by reference.

### BACKGROUND

A tree stand is used to support a hunter in an elevated position on a tree above game. The tree stand is secured to the tree trunk and must be capable of supporting weight of the hunter in the elevated position. Typically, the tree stand includes a seat and a footrest for the hunter. One type of tree stand is sized and shaped to support two or more hunters.

### SUMMARY OF THE INVENTION

In one aspect, a tree stand for securing to a tree trunk to support a user at an elevated position on the tree trunk generally comprises a mounting frame and a platform mounted on the mounting frame and arranged for supporting weight of the user. An engagement component is secured to the mounting frame for engaging the tree trunk. The engagement component includes spaced apart engagement arms. Each engagement arm is pivotable relative to the mounting frame generally toward the other engagement arm generally within a plane so that the engagement component is generally conformable to a circumferential segment of the tree trunk.

In another aspect, a tree stand for securing to a tree trunk to support a user at an elevated position on the tree trunk generally comprises a mounting frame and a platform mounted on the mounting frame and arranged for supporting weight of the user. Rails are spaced apart from one another and extend generally forward from the mounting frame. The rails are disposed above and generally adjacent to either side of the platform to at least partially define a confined space between the rails. The rails are operatively connected to the mounting frame for selective, independent lateral movement relative to the mounting frame to increase and decrease the confined space.

In yet another aspect, a tree stand for securing to a tree trunk to support a user at an elevated position on the tree trunk generally comprises a platform mounted on the mounting frame and arranged for supporting weight of the user. Rails are secured to the mounting frame. Each rail includes a rear rail arm extending from the mounting frame and a front rail arm extending from the rear rail arm. The front rail arm is selectively pivotable relative to the rear rail arm.

In another aspect, a tree stand for securing to a tree trunk to support a user at an elevated position on the tree trunk generally comprises a mounting frame and a platform mounted on the mounting frame and arranged for supporting weight of the user. A canopy assembly is secured to the mounting frame and adapted to cover the platform. The canopy assembly comprises a frame and a cover secured to the frame. The frame includes a rear member and a front member pivotably secured to the rear member. By pivoting the front member relative to the rear member, the canopy assembly is configurable between an extended, covering position, in which the front member covers at least part of the platform, and a retracted, uncovering position, in which the front member covers less of the platform than in the extended, covering position.

### BRIEF DESCRIPTION OF THE DRAWINGS

FIG. 1 is a perspective of a tree stand with a ladder secured thereto;

FIG. 2 is an exploded view of the tree stand;

FIG. 3 is a rear perspective of the tree stand;

FIG. 4 is an enlarged, fragmentary top plan of the tree stand secured to a tree trunk shown in phantom;

FIG. 5 is a front elevation of the tree stand with rails of the stand being in laterally outermost positions and front arms of the rails being in a horizontal position;

FIG. 6 is similar to FIG. 5 but with the rails being in a laterally innermost position;

FIG. 7 is similar to FIG. 5 but with the front arm of one of the rails extending at an upward angle relative to horizontal position;

FIG. 8 is a fragmentary, left elevation of the tree stand with the front arm of the left rail being in a horizontal position;

FIG. 9 is similar to FIG. 8 with the front arm extending at an upward angle relative to horizontal position.

FIG. 10 is an enlarged perspective of a canopy assembly removed from the tree stand, with the canopy assembly being in an extended, covering position; and

FIG. 11 is similar to FIG. 10 but with the canopy assembly being in a retracted, uncovering position.

Corresponding reference characters indicate corresponding parts throughout the drawings.

### DETAILED DESCRIPTION OF THE DRAWINGS

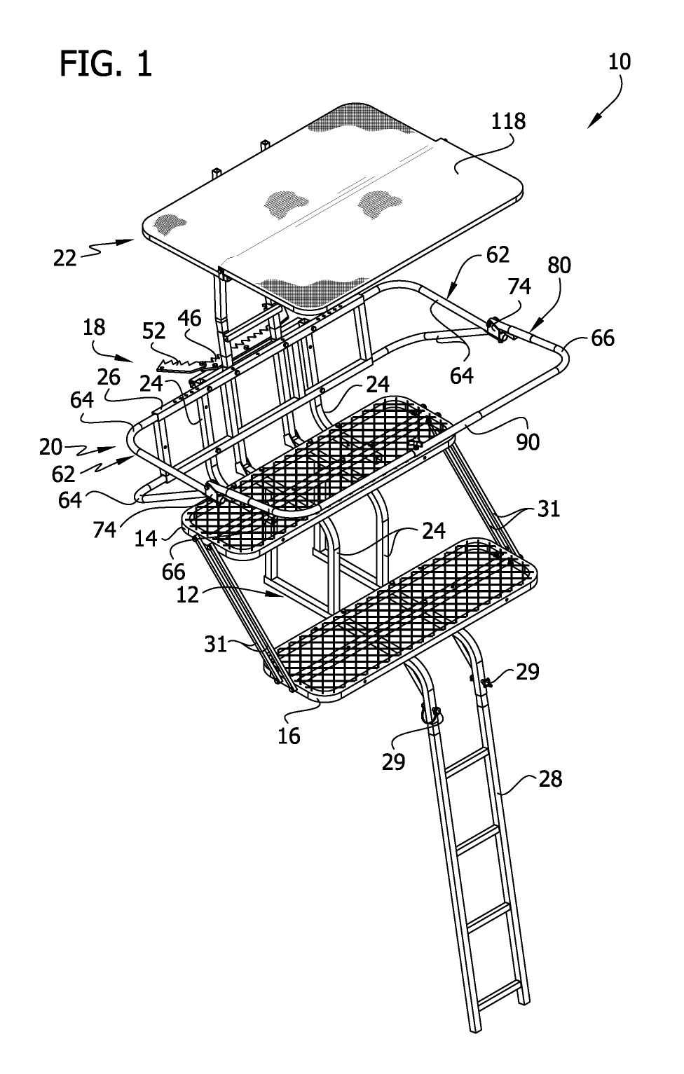

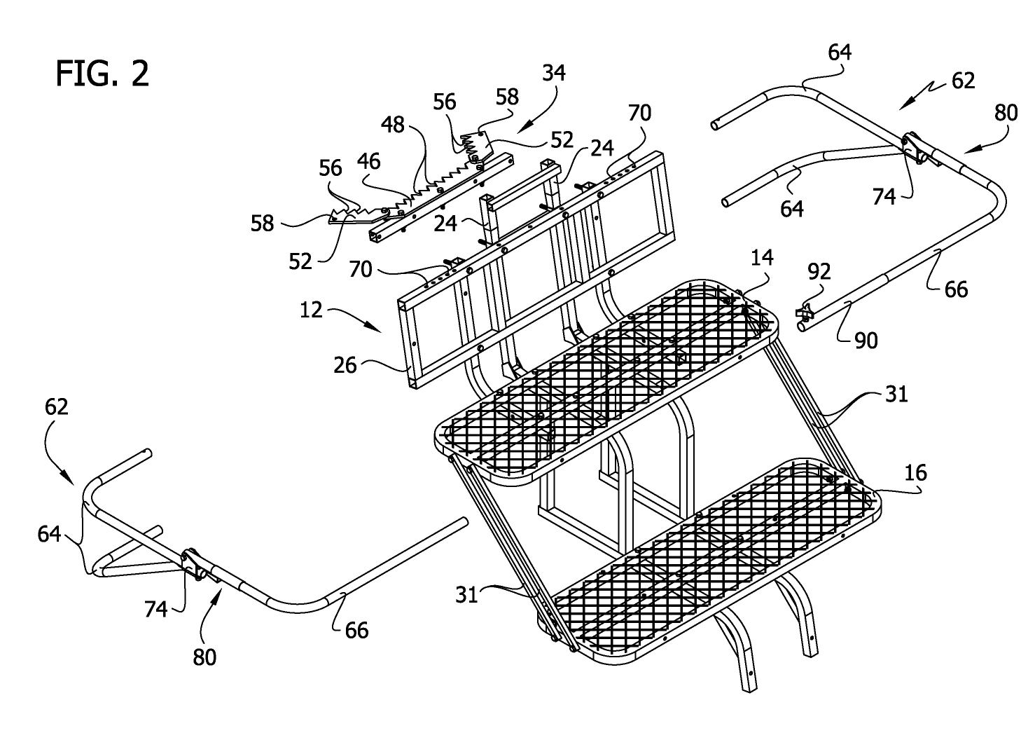

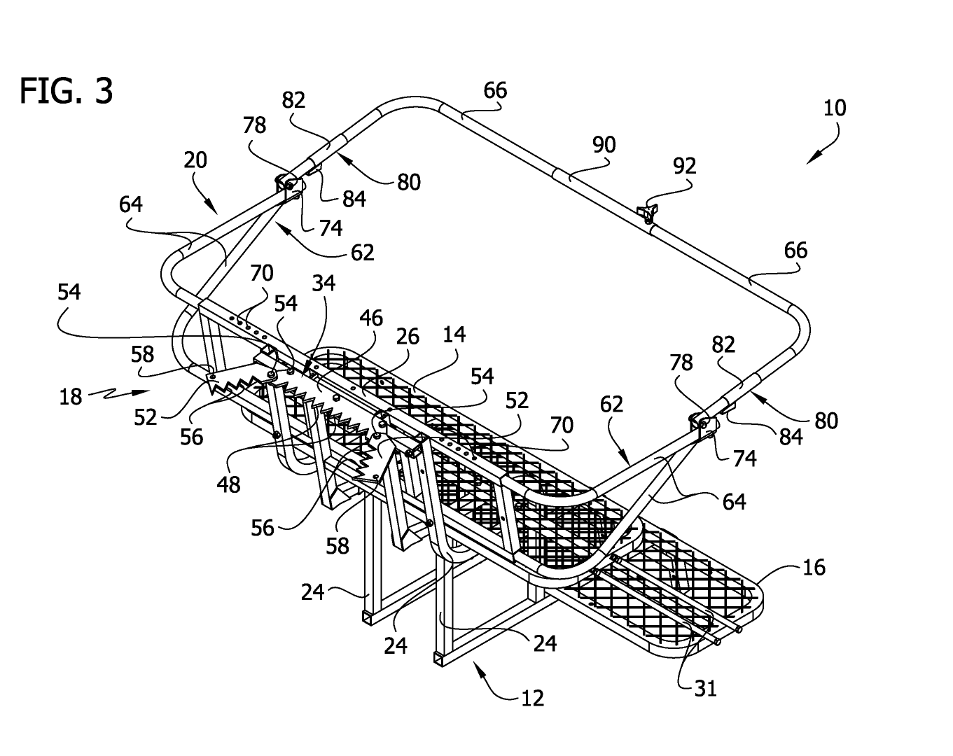

Referring now the drawings, a tree stand for securing to a tree trunk to support a user at an elevated position on the tree trunk is generally indicated at 10. Referring to FIGS. 1-3, the tree stand 10 includes a mounting frame, generally indicated at 12, on which a seat 14 (broadly, a first platform), a footrest 16 (broadly, a second platform), a securement assembly, generally indicate at 18, a rail assembly, generally indicated at 20, and a canopy assembly, generally indicated at 22, are mounted. The mounting frame 12 includes a central, upright support structure 24 and a horizontal or cross-wise support structure 26 secured to and extending generally transversely to an upper portion of the upright support structure. The cross-wise support structure 26 may be secured to the upright support structure 24 by fasteners (e.g., bolts) or in other ways, such as by welding. The upright support structure 24 and the cross-wise support structure 26 each comprises a plurality of generally rigid frame members that may be formed from tubular steel stock, for example, and may be secured to one another by fasteners (e.g., bolts) or welding or in other suitable ways. As shown in FIG. 1, a ladder 28 is removably securable to the lower portion of the upright support structure 24, such as by removable pins 29.

The seat 14 of the tree stand 10 is secured to an intermediate portion of the upright support structure 24 that projects forward from the upper portion. The seat 14 may be secured to the upright support structure 24 by fasteners (e.g., bolts) or in other ways. The seat 14 comprises a generally planar grating structure that is sized and shaped to support two seated persons. The seat 14 may be of other configurations without departing from the scope of the present invention.

The footrest 16 is secured to a lower portion of the upright support structure 24 that extends downward from the intermediate portion. The footrest 16 is generally parallel to the seat 14 and at least a portion of the footrest is forward of the seat. Lateral braces 31 connect the seat 14 to the footrest 16. The footrest comprises a generally planar grating structure that is sized and shaped to support feet of the two seated persons on the seat. The footrest 16 may be of other configurations without departing from the scope of the present invention.

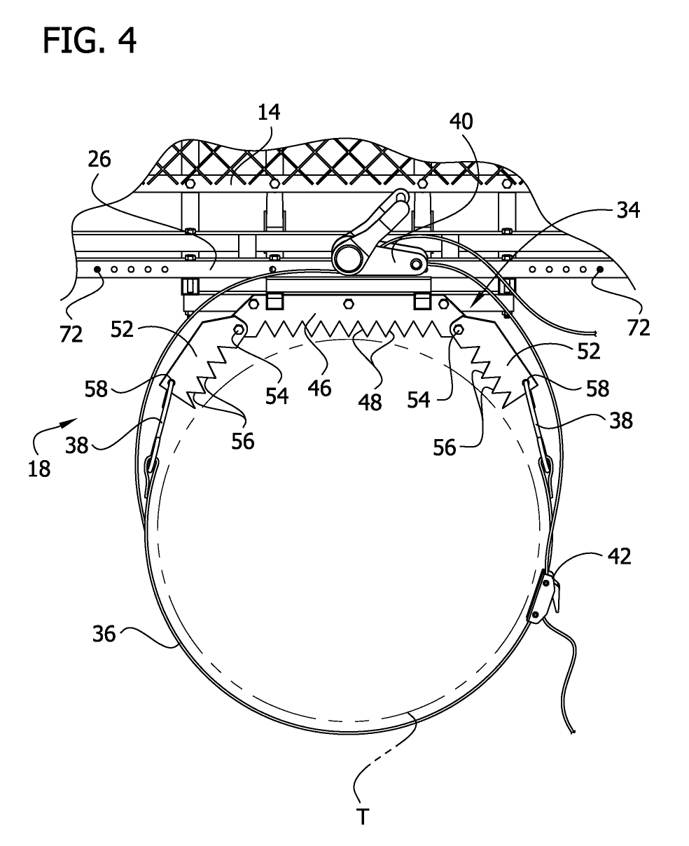

Referring to FIGS. 1-4, the securement assembly 18 includes an engagement component 34 and a ratchet strap 36. The engagement component 34 is secured at rear side of the upper portion of the upright support structure 24. The ratchet strap 36 of the securement assembly 18 includes hooks 38 at opposite ends of the strap and a ratcheting mechanism 40 for tightening the strap around the tree trunk T (FIG. 4). The ratchet strap 36 may comprise two or more strap segments secured to the ratcheting mechanism 40. A buckle 42 allows the length of the ratchet strap 36 to be adjusted.

The engagement component 34 of the securement assembly 18 includes an elongate engagement base 46 extending generally horizontally or cross-wise with respect to the upright support structure 24. The engagement base 46 includes teeth 48 spaced apart along a length of the base and projecting rearward from the base. Engagement arms 52 are secured adjacent to opposite longitudinal ends of the engagement base 46 by pivot fasteners 54 (e.g., bolts). The engagement arms 52 are freely pivotable with respect to the engagement base 46 and the mounting frame 12 about generally vertical imaginary axes so that the arms can pivot toward and away from one another within a generally horizontal plane. Each engagement arm 52 includes outwardly projecting teeth 56 spaced apart along a length of the arm. As explained below, each engagement arm 52 has an opening 58 at a free end margin for receiving a respective one of the hooks 38 of the ratchet strap 36. The engagement base 46 and the engagement arms 52 may be formed from metal plates, such as steel plates, or in other ways.

Referring to FIG. 1-4, the securement assembly 18 is used to secure the tree stand 10 to a tree trunk T. In use, the tree stand 10 is positioned at an elevated position on the tree T so that the teeth 48 of the engagement base 46 of the engagement component 34 engage the tree trunk T. The engagement arms 52 may be pivoted inward toward one another and the tree trunk T so that the teeth 56 on the arms engage the tree trunk and so that engagement component 34 generally conforms to a segment of the circumference of the tree trunk. One of the hooks 38 of the ratchet strap 36 is inserted into the opening 58 in one of the engagement arms 52. The ratchet strap 36 is then wrapped around the circumference of the tree trunk T, around the upper portion of the upright support structure 24 and back around the tree trunk where the hook 38 at the other end of the ratchet strap is inserted into the opening 58 in the other engagement arm 52. It will be appreciated that each end segment of the ratchet strap 36 is wrapped around the tree trunk T and hooked into the respective engagement arm 52 on the opposite side. When both of the hooks 38 are inserted in the respective openings 58 in the engagement arms 52, the ratcheting mechanism 40 should be in front of the upright support structure 24. If necessary, a coarse adjustment of the length of the ratchet strap 36 can be made using the buckle 42 to properly position the ratcheting mechanism 40.

With the ratchet strap 36 properly wrapped around the tree trunk T and the upright support structure 24, the strap is tightened using the ratcheting mechanism 40. Tightening the ratchet strap 36 moves the stand 10 rearward, toward the tree trunk T so that the teeth 48 on the engagement base 46 bite into the tree trunk. Simultaneously, tightening the ratchet strap 36 pivots the engagement arms 52 inward toward one another and the tree trunk T so that the teeth 56 on the engagement arms 52 also bite into and grip the tree trunk.

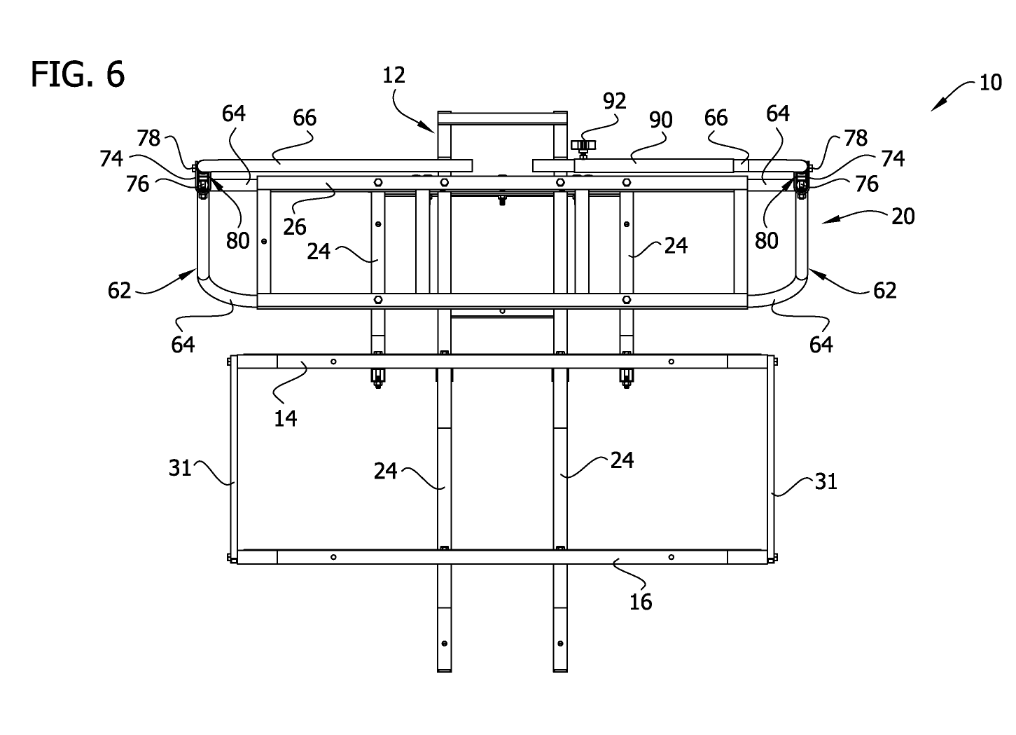

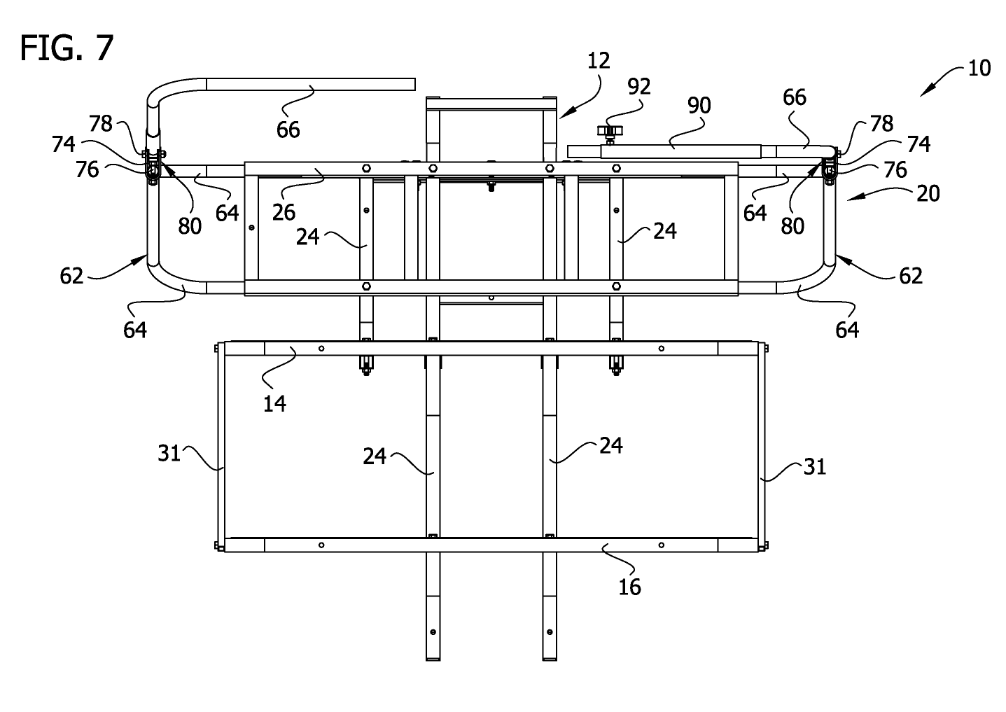

Referring to FIGS. 1 and 5-9, the rail assembly 20 includes two rails 62 mounted on opposite ends of the cross-wise support structure 26. The rails 62 may be used for propping up a weapon or supporting a shooting stance of the user(s). The rails 62 are also used to confine the user(s) within a defined space between the rails and to restrain the user(s) from falling out of the stand 10. As will be explained below, the rails 62 are adapted for selective, independent lateral movement relative to the mounting frame 12 to increase and decrease the confined space. Each rail 62 includes generally L-shaped upper and lower rear rail arms 64 and a generally L-shaped front rail arm 66. The use of upper and lower rear rail arms 64 help to rigidify the rails 62 so they are steady when used as gun supports. It is understood that each rail 62 may include only one rear rail arm without departing from the scope of the present invention. The upper and lower rear rail arms 64 are telescopingly secured to a respective one of the ends of the cross-wise support structure 26, and the generally L-shaped front rail arms 66 are pivotally secured to the rear arms. Together, the rear and front rail arms, 64, 66, respectively, make the rails 62 generally C-shaped defining a front portion, a rear portion and an intermediate portion between the front and rear portions.

The upper and lower rear rail arms 64 of each rail 62 are telescopingly received in and extend laterally outward from the cross-wise support structure 26. Openings 70 spaced apart along a length of the cross-wise support structure 26 selectively receive a retractable, spring-biased pin 72 (broadly, a locking mechanism) extending radially outward from at least one of the upper and lower rear rail arms 64 to fix a lateral position of the corresponding rail 62 with respect to the cross-wise support structure. As will be appreciated, the user(s) can easily and independently adjust the lateral position of each rail 62 to his/her liking without affecting the lateral position of the other rail. Moreover, the user(s) can adjust the horizontal spacing or distance between the two rails 62 to increase or decrease the confined spaced defined by the rail assembly 20 and give the user(s) more or less space between another user seated on the stand 10 and the rails 62. Other ways of releasably locking the lateral positions of the rails 62 relative to the mounting frame 12 do not depart from the scope of the present invention.

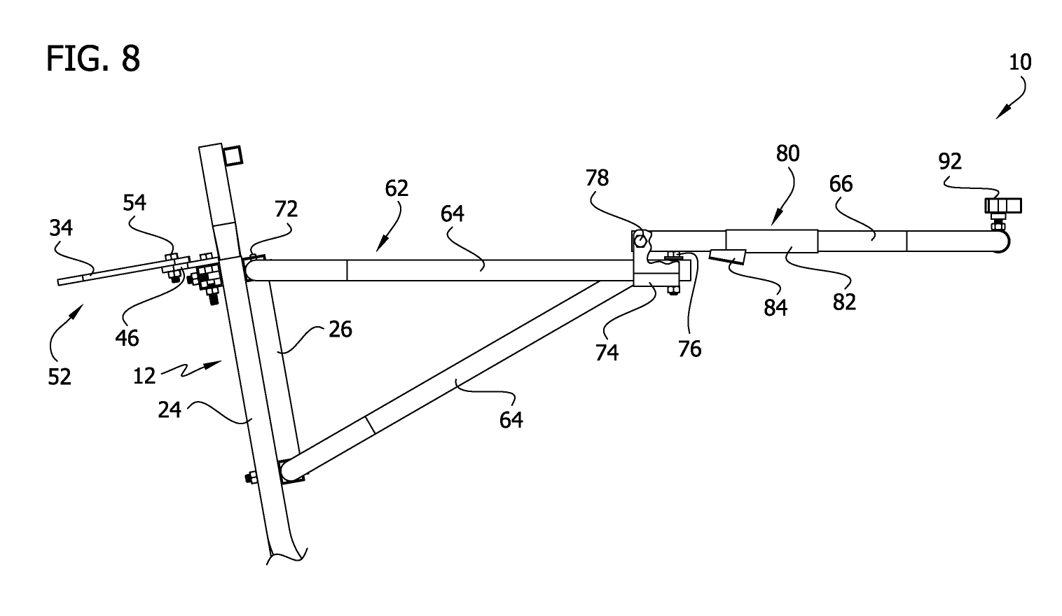

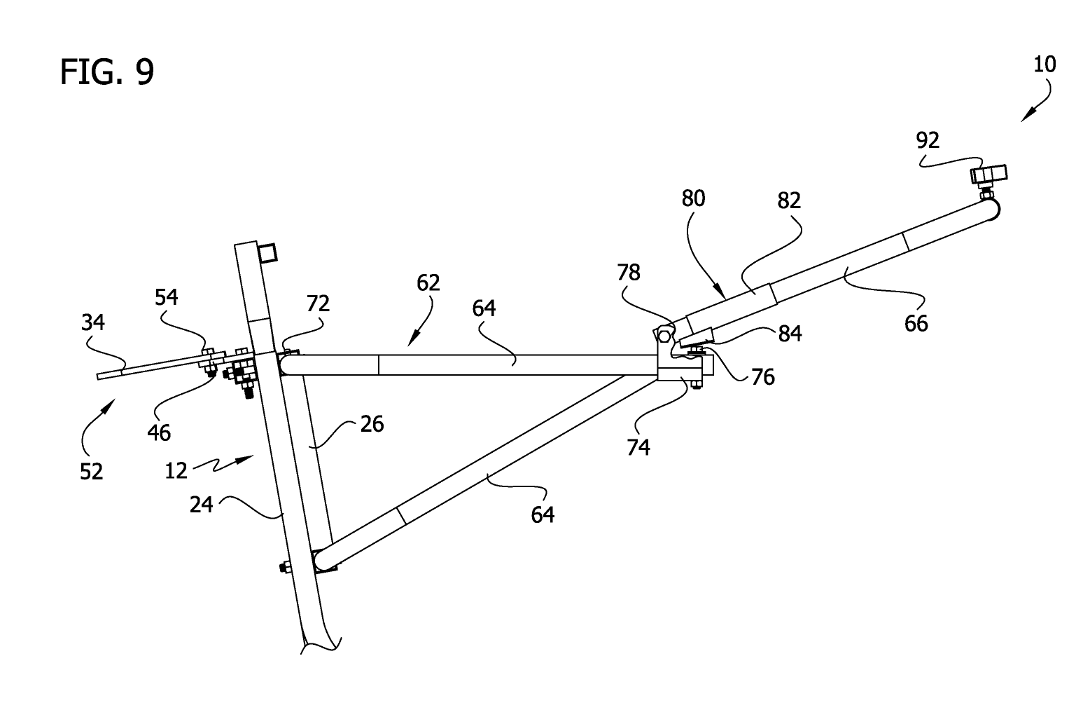

The upper and lower rear rail arms 64 are bent, or otherwise formed, so that the rear arms generally extend forward. The upper and lower rear rail arms 64 converge as they extend forward and are fixedly secured to a connection hub 74 that pivotally connects the front rail arm 66 of the rail to the upper and lower rear arms. Referring to FIGS. 8 and 9, the connection hub 74 includes a generally U-shaped bracket defining a channel in which the upper and lower rear rail arms 64 are fixedly secured. A bolt 76 extends through each associated upper and lower rear arms 64 and through each corresponding hub 74 to fixedly secure the connection hub 74 to the corresponding rear rail arms. In the illustrated embodiment, an entirety of each upper rear rail arm 64 lies in a same horizontal plane, while each lower rear arm is bent in an upward direction, toward the corresponding upper rear arm. Moreover, a portion of each lower rear rail arm 64 received in the connection hub 74 is swaged.

The front rail arm 66 of each rail 62 is pivotally secured to and extends forward from the connection hub 74. Each front rail arm 66 is bent to extend inwardly toward the other one of the rails 62. A pivot fastener 78 (e.g., a bolt) extends transversely through each connection hub 74 and the corresponding front rail arm 66 so that the front arm pivots freely about a generally horizontal axis of the pivot fastener. Each front rail arm 66 is secured to the hub 74 above the upper rear rail arm 64 so that the upper rear arm and/or the bolt 76 acts as a stop to prevent the front arm from pivoting downward past a lowermost vertical position. Other ways of limiting the rotation of the front rail arms 66, including other ways of forming a stop in the connection hub 74, is within the scope of the present invention. In the lowermost vertical position, the front rail arms 66 lie generally in a horizontal plane (i.e., they do not extend downward) generally parallel to a plane of the upper rear rail arms 64. It is to be understood that the front arms may extend downward slightly in the lowermost vertical position or make another angle with the plane of the upper rear rail arms.

Each rail 62 includes a vertical positioning component 80 slidably received on the corresponding front rail arm 66 for adjusting the vertical position of the front arm. The vertical positioning component 80 includes a sleeve 82 and a wedge member 84 secured to an underside of the sleeve. To adjust the vertical position of each front rail arm 66 relative to the seat 14 of the stand 10, the front arm is pivoted upward to a selected vertical position, and the vertical positioning component 80 is slid toward the connection hub 74 until the wedge member 84 engages the upper rear arm and/or bolt 76 or other stop member (see, FIG. 9). With the wedge member 84 engaging the rear rail arm 64, the front rail arm 66 extends at an angle other than horizontal so that the front arm is in a raised position. Because the wedge member 84 is sloped, the vertical positioning component 80 will maintain the front rail arm 66 in a plurality of different raised positions up to and including an uppermost position, in which the wedge is fully received between the upper rear arm and/or bolt 76 or other stop member and the front arm.

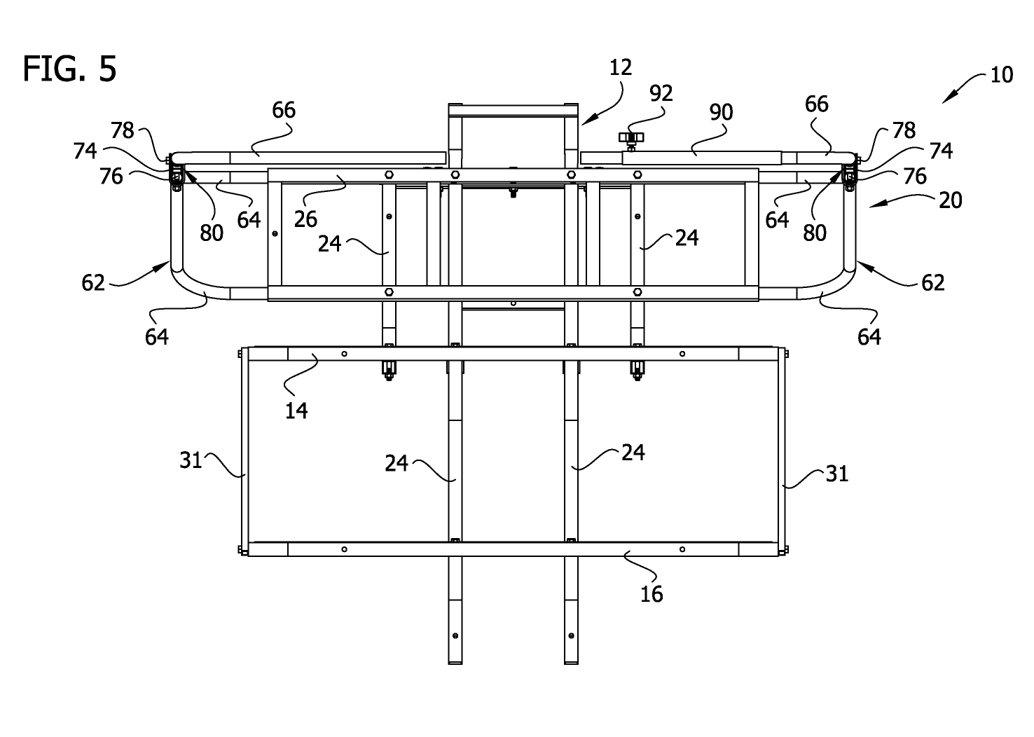

As can be appreciated, the front rail arm 66 of each rail 62 is pivotable independent of the front arm of the other rail. Accordingly, where two users are seated on the tree stand 10, each user can adjust his/her own rail 62 to his/her own liking without affecting the position of the other user's rail. Alternatively, the rail assembly 20 includes a linking sleeve 90 (broadly, a linking member) slidably received on one of the front rail arms 66 (FIGS. 5-7). The linking sleeve 90 can be slid to a linking position in which the sleeve is disposed over and connects the front rail arms 66 to form a single rail of the rail assembly 20 (see, FIG. 1). The linking sleeve 90 comprises a generally elongate tube and a set screw 92 having a large knob for fixing the position of the tube over the rails 62. Securing the rails 62 to one another using the linking sleeve 90 further rigidities and strengthens the front rail arms 66 of the rails for both improving support when the rails are used as a prop, and for improving safety because the users are essentially enclosed within the confined spaced defined by the cross-wise support structure 26 and the rail assembly 20.

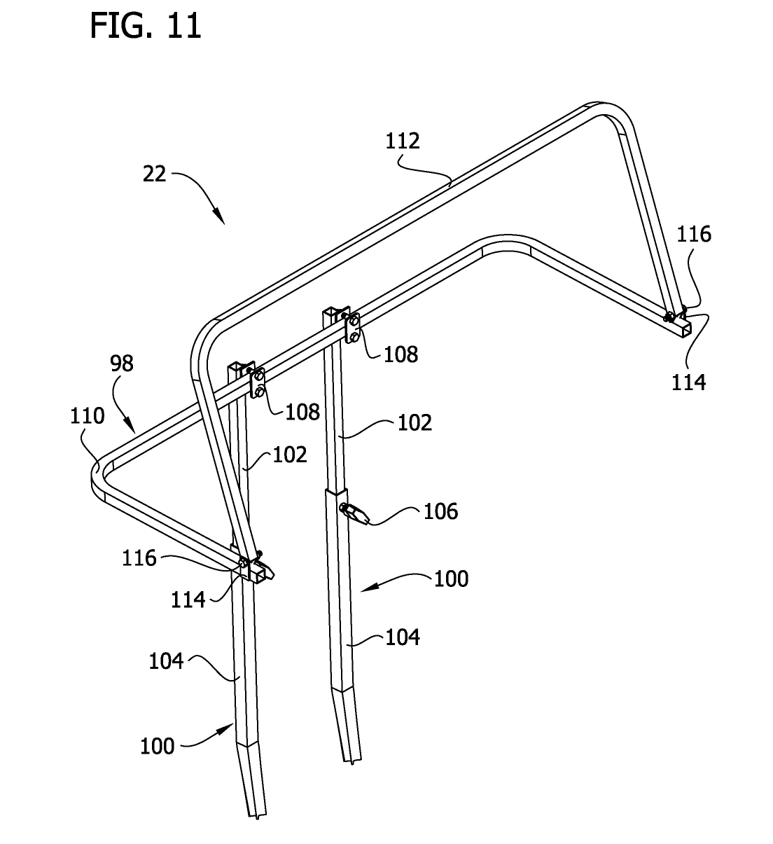

Referring to FIGS. 1, 10 and 11, the canopy assembly 22 includes a retractable frame, generally indicated at 98, secured to two telescoping posts, each being indicated generally at 100. The telescoping posts 100 have lower end portions that are swaged for removable insertion into the upper portion of the upright support structure 24. Other ways of connecting the canopy assembly 22 to the mounting frame 12 do not depart from the scope of the present invention. Each telescoping post 100 comprises an upper post member 102 slidably received within a lower post member 104, and a set screw 106 for fixing the position of the upper post member relative to the lower post member. As such, the height of the frame 98 above the seat is infinitely adjustable within a range (FIG. 11). Other ways of making the posts 100 adjustable in height do not depart from the scope of the invention. Moreover, the posts 100 may not be adjustable in height without departing from the scope of the invention.

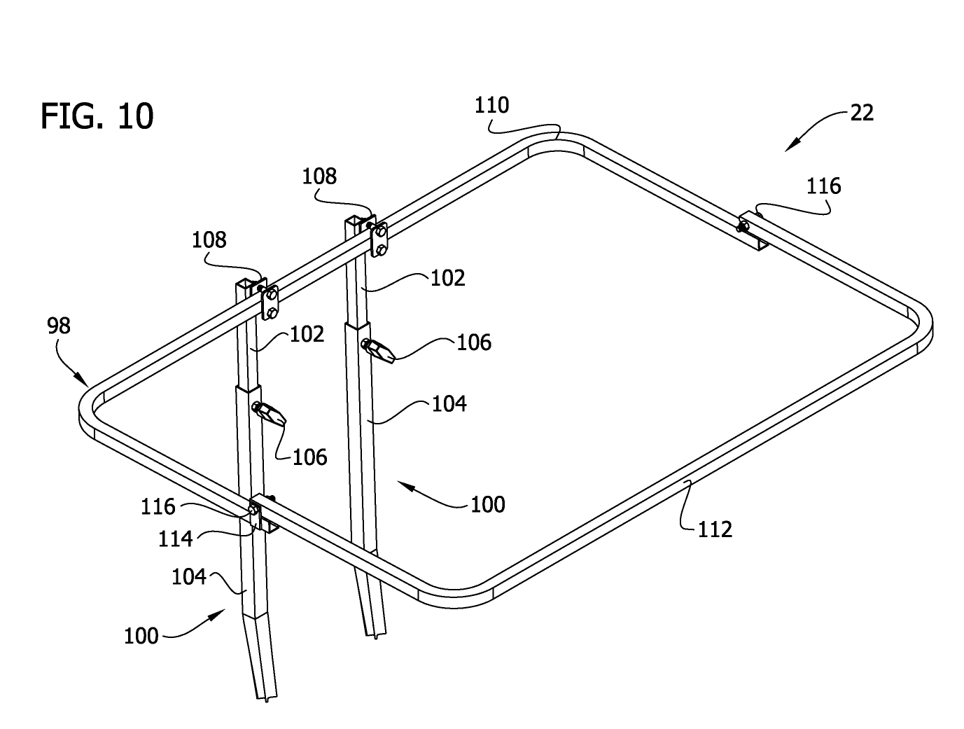

The retractable frame 98 is secured to upper portions of the telescoping posts 100 by brackets or clamps 108 so that the frame extends forward from the posts, over the seat 14. The retractable frame 98 includes a U-shaped rear member 110 secured to the posts 100, and a U-shaped front member 112 pivotably secured to the rear member by a bracket 114 and pivot fasteners 116 (e.g., bolts). As shown in FIG. 1, a cover 118, such as a waterproof cover, is secured around a perimeter of the frame 98. For clarity of illustration the cover 118 has been removed in FIGS. 10 and 11. In use, the front member 112 is pivotable relative to the rear member 110 about a generally horizontal axis to configure the canopy assembly 22 between an extended, covering position (FIGS. 1 and 10), in which the front member covers at least part of the seat 14 below, and a retracted, uncovering position (FIG. 11), in which the front member does not cover (or covers less of) the seat. Other ways of making the canopy assembly 22 retractable do not depart from the scope of the invention. Moreover, the canopy system 22 may not be retractable without departing from the scope of the invention.

Having described the invention in detail, it will be apparent that modifications and variations are possible without departing from the scope of the invention defined in the appended claims.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A tree stand for securing to a tree trunk to support a user at an elevated position on the tree trunk, the tree stand comprising:
a mounting frame;
a platform mounted on the mounting frame and arranged for supporting weight of the user;
an engagement component secured to the mounting frame for engaging the tree trunk, the engagement component including spaced apart engagement arms, each engagement arm being pivotable relative to the mounting frame generally toward the other engagement arm within a generally plane so that the engagement component is generally conformable to a circumferential segment of the tree trunk.

2. A tree stand as set forth in claim 1 wherein the engagement component further includes an engagement base fixedly secured to the mounting frame, the engagement arms being pivotably secured to the base.

3. A tree stand as set forth in claim 2 wherein each of the engagement arms includes a plurality of teeth spaced apart along a length of the engagement arm and the engagement base includes a plurality of teeth spaced apart along a length of the engagement base.

4. A tree stand as set forth in claim 1 wherein each of the engagement arms has an opening at a free end margin of the engagement arm.

5. A tree stand as set forth in claim 4 wherein the engagement component further includes a ratchet strap, the ratchet strap including hooks at opposite ends of the ratchet strap for insertion into the openings in the engagement arms, and a ratcheting mechanism for adjusting the length of the ratchet strap.

6. A tree stand for securing to a tree trunk to support a user at an elevated position on the tree trunk, the tree stand comprising:
a mounting frame;
a platform mounted on the mounting frame and arranged for supporting weight of the user;
rails spaced apart from one another and extending generally forward from the mounting frame, the rails being disposed above and generally adjacent to either side of the platform to at least partially define a confined space between the rails, the rails being operatively connected to the mounting frame for selective, independent lateral movement relative to the mounting frame to selectively increase and decrease the confined space.

7. A tree stand as set forth in claim 6 wherein the rails are telescopingly received in the mounting frame.

8. A tree stand as set forth in claim 7 further comprising locking mechanisms for selectively and releasably locking the rails in selective lateral positions relative to the mounting frame.

9. A tree stand as set forth in claim 7 wherein each rail is generally C-shaped, the rails having rear portions telescopingly received in the mounting frame and front portions, spaced from the rear portions that extend toward one another.

10. A tree stand as set forth in claim 9 further comprising a linking sleeve slidably received on at least one of the front portions of the rails, the linking sleeve being adapted to selectively connect the front portions of the rails to one another.

11. A tree stand as set forth in claim 7 further comprising an engagement component secured to the mounting frame for engaging the tree trunk, the engagement component including spaced apart engagement arms, each engagement arm being pivotable relative to the mounting frame generally toward the other engagement arm generally within a plane so that the engagement component is generally conformable to a circumferential segment of the tree trunk.

12. A tree stand as set forth in claim 1 further comprising a canopy assembly secured to the mounting frame and adapted to cover the platform.

13. A tree stand for securing to a tree trunk to support a user at an elevated position on the tree trunk, the tree stand comprising:
a mounting frame;
a platform mounted on the mounting frame and arranged for supporting weight of the user;
rails secured to the mounting frame, each rail including a rear rail arm extending from the mounting frame and a front rail arm extending from the rear rail arm, the front rail arm being selectively positionable relative to the rear rail arm.

14. A tree stand as set forth in claim 13 further comprising a connection hub secured to each of the rear rail arms, each front rail arm being pivotally secured to the connection hub.

15. A tree stand as set forth in claim 14 wherein the connection hub comprises a generally U-shaped bracket.

16. A tree stand as set forth in claim 14 further comprising vertical positioning component slidably received on each of the front rail arms for retaining the front rail arm in a selected angle.

17. A tree stand as set forth in claim 16 wherein the vertical positioning component includes a sleeve and a wedge member secured to an underside of the sleeve.

18. A tree stand as set forth in claim 13 wherein each rear rail arm is telescopingly received in the mounting frame for selective lateral movement relative to the mounting frame.

19. A tree stand as set forth in claim 13 further comprising a canopy assembly secured to the mounting frame and covering the platform.

20. A tree stand for securing to a tree trunk to support a user at an elevated position on the tree trunk, the tree stand comprising:
a mounting frame;
a platform mounted on the mounting frame and arranged for supporting weight of the user;
a canopy assembly secured to the mounting frame and adapted to cover the platform, the canopy assembly comprising a frame and a cover secured to the frame, the frame including a rear member and a front member pivotably secured to the rear member,
wherein by pivoting the front member relative to the rear member, the canopy assembly is configurable between an extended, covering position, in which the front member covers at least part of the platform, and a retracted, uncovering position, in which the front member cover less of the platform than in the extended, covering position.
